(19) United States
(12) Patent Application Publication
(10) Pub. No.: US 2019/0217380 A1
(43) Pub. Date: Jul. 18, 2019

(54) MULTI-DIRECTIONAL UNIBODY CASTING MACHINE FOR A VEHICLE FRAME AND ASSOCIATED METHODS

(71) Applicant: Tesla, Inc., Palo Alto, CA (US)

(72) Inventor: Matthew Kenneth Kallas, St. Augustine, FL (US)

(21) Appl. No.: 15/874,348

(22) Filed: Jan. 18, 2018

(51) Int. Cl. B22D 17/22; B22D 17/20; B22D 17/00

(52) U.S. Cl. CPC B22D 17/2236; B62D 23/005; B22D 17/002; B22D 17/2015

(57) ABSTRACT

A multi-directional casting machine for casting a frame of a vehicle is described herein. The casting machine may include a central hub having a cover die portion and a plurality of ejector die portions translatable relative to the cover die portion and configured to meet at the central hub. The plurality of ejector die portions include first and second ejector die portions configured to translate along a first axis and a third ejector die portion configured to translate along a second axis extending substantially perpendicular to the first axis between closed and open positions. The first, second, and third ejector die portions are adjacent a first, second, and third sides, respectively, of the cover die portion in the closed positions and spaced apart from the cover die portion in the open positions. The plurality of ejector die portions form a mold cavity corresponding to a portion of a vehicle frame.

### BACKGROUND

The present disclosure relates generally to manufacturing a vehicle frame, and more particularly to a multi-directional die casting machine for casting a unibody vehicle frame and associated methods thereof.

Conventional die casting, also known as high-pressure die casting (HPDC), is a metal casting process that has been in use for over a hundred years. Die casting typically includes forcing or injecting molten metal under high pressure into a mold cavity. The mold cavity is formed using two die portions which have been machined into a shape of the desired casting. Depending on metal material type being used, a hot or cold chamber die casting machine may be used, as well as squeeze casting methods, in addition to over-molding, where alloy is casted over/around existing substrates in order to achieve higher structural properties of an end product. One die portion is called a “cover die portion” and the other die portion an “ejector die portion”, and where they meet “the parting line” Conventionally, the cover die portion includes a sprue or shot hole configured to allow molten metal to flow into the dies from an injector fluidly coupled to the sprue or shot hole, and is attached to a stationary platen of a casting machine. The ejector die portion typically includes ejector pins and/or a plate to push the casting out of the ejector die portion (e.g., after solidification and the dies open), and is attached to a movable platen of the casting machine.

Typically, in the context of vehicle frame manufacturing and the die casting process, multiple die casting machines are each used to cast different components of a vehicle frame. For example, a single die casting machine cell in a factory may be dedicated to casting a single frame component. These components from each casting machine are then assembled or secured together (e.g., via welding) by factory workers or robotic systems to form a vehicle frame (e.g., a unibody vehicle frame). Because die casting generally involves higher capital costs relative to other casting and manufacturing processes including assembly of many individual components (e.g., due to high costs of casting equipment and metal dies), there remains a need for an improved die casting machine and associated methods thereof, particularly as related to casting a vehicle frame to reduce work required to achieve a final assembled product. The present disclosure describes embodiments of die casting machines and methods thereof that may reduce build time, operation costs, costs of manufacturing, factory footprint, factory operating costs, tooling costs, and/or quantity of equipment. Such casting machines may reduce a number of casting machines or actual castings required to cast a complete or substantially complete vehicle frame (e.g., to less than six, less than five, less than four, less than three, less than two, or one casting machine(s)).

### SUMMARY

The present disclosure relates generally to manufacturing and assembling a vehicle frame, and more particularly to a multi-directional die casting machine for casting a vehicle frame and associated methods thereof such multi-directional casting machines may be suitable for casting a unibody vehicle frame, and more specifically for an electrical vehicle unibody frame. In some embodiments, multiple portions of the vehicle frame may be integrally formed or casted without the need for further assembly and attachment (e.g., welding, rivets, etc.). This may reduce a number of castings and/or steps for manufacturing or casting a substantially complete vehicle frame. For example, the die casting machine as described herein may reduce a number of casting machines or actual castings required to cast a complete or substantially complete vehicle frame (e.g., to less than six, less than five, less than four, less than three, less than two, or to one casting(s) or casting machine(s)). Accordingly, this may reduce costs associated with manufacturing including, but not limited to, factory operating costs, tooling costs, time, and other equipment and labor costs.

In one aspect, a multi-directional casting machine for a vehicle frame configured in accordance with embodiments of the present disclosure, includes: a central hub having a cover die portion and a plurality of ejector die portions translatable relative to the cover die portion. The plurality of ejector die portions are configured to meet at the central hub. The plurality of ejector die portions includes a first ejector die portion configured to translate along a first axis between a closed position and an open position. The first ejector die portion is adjacent a first side of the cover die portion in the closed position and spaced apart from the cover die portion in the open position. A second ejector die portion is configured to translate along the first axis between a closed position and an open position. The second ejector die portion is adjacent a second side of the cover die portion opposite the first side in the closed position and spaced apart from the cover die portion in the open position. A third ejector die portion is configured to translate along a second axis extending substantially perpendicular to the first axis between a closed position and an open position. The third ejector die portion is adjacent a third side of the cover die portion in the closed position and spaced apart from the cover die portion in the open position. The plurality of ejector die portions form a mold cavity corresponding to at least a portion of a vehicle frame.

In another aspect, a multi-directional casting machine for a vehicle frame includes a central hub configured to receive a plurality of translatable ejector die portions. The plurality of ejector die portions are configured to form a mold cavity when received by the central hub. The mold cavity corresponds to at least a portion of a vehicle frame. The machine including an ejection system operably coupled to the central hub and configured to eject a casting of the vehicle frame in an upward direction along a substantially vertical axis relative to the central hub after the vehicle frame has been casted in the mold cavity.

An exemplary method of casting a frame of a vehicle according to embodiments of the present disclosure includes the steps of: translating a first ejector die portion towards a first side of a cover die portion along a first axis in a first direction and translating a second ejector die portion towards a second opposing side of the cover die portion along the first axis in a second direction opposite the first direction. The cover die portion is fixedly positioned on a central hub. The method further includes injecting molten metal into a mold cavity formed at least partially by mold cavity portions of the first and second ejector die portions to form a casting corresponding to at least a portion of a vehicle frame. The method includes ejecting the casting out of the first and second ejector die portions and translating the first and second ejector die portions away from the cover die portion in opposite directions along the first axis.

### BRIEF DESCRIPTION OF THE DRAWINGS

FIG. 1A is an illustration of a multi-directional casting machine for a vehicle frame configured in accordance with an embodiment of the present disclosure.

FIG. 1B is an illustration of a cover die of the multi-directional casting machine of FIG. 1A configured in accordance with an embodiment of the present disclosure.

FIG. 2 is an illustration of a multi-directional casting machine for a vehicle frame configured in accordance with another embodiment of the present disclosure.

FIG. 3 is a top view of a portion of a multi-directional casting machine for a vehicle frame configured in accordance with an embodiment of the present disclosure.

FIG. 4A is a cross-sectional view of a portion of the multi-directional casting machine of FIG. 1A.

FIG. 4B is a close-up view of a portion of the casting machine of FIG. 4A illustrating certain features of the casting machine in accordance with an embodiment of the present disclosure.

FIG. 5 is a cross-sectional view of a central hub of the multi-directional casting machine of FIG. 1A configured in accordance with an embodiment of the present disclosure.

FIG. 6 is an illustration of an example method of casting a vehicle frame configured in accordance with an embodiment of the present disclosure.

### DETAILED DESCRIPTION

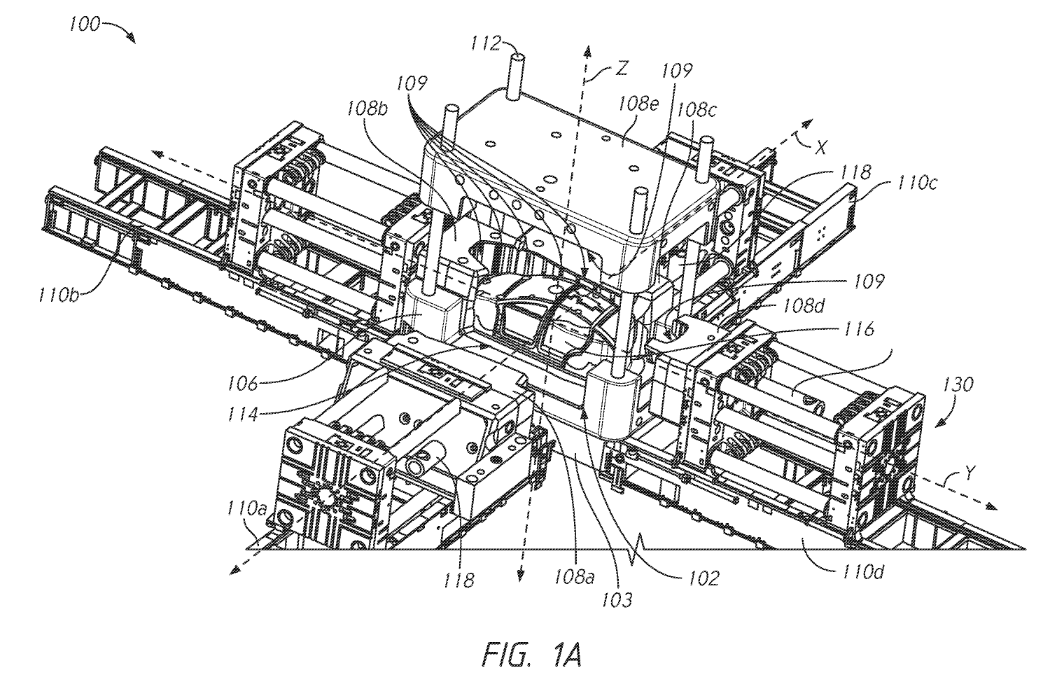

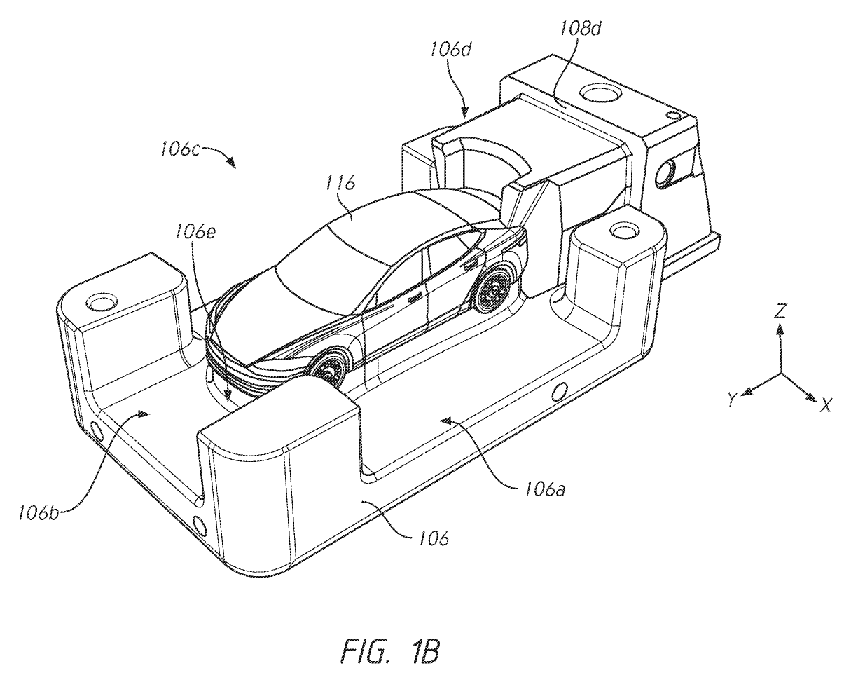

FIG. 1A is an illustration of a multi-directional casting machine 100 for a vehicle frame configured in accordance with embodiments of the present disclosure. In certain embodiments, the casting machine 100 may be configured to integrally cast a complete or substantially complete unibody frame for a vehicle (e.g., an electric vehicle). In other embodiments, the casting machine 100 may be configured to cast portions (e.g., a left side, a right side, a roof, a floor, a front side, and/or a rear side) of a unibody frame. In such embodiments, multiple casting machines may be required to cast the entire vehicle frame. However, as noted above, a casting machine 100 as disclosed herein may reduce a number of casting machines or actual castings required to cast a complete or substantially complete vehicle frame (e.g., to less than six, less than five, less than four, less than three, less than two, or to one casting(s) or casting machine(s)). For example, the casting machine 100 may be configured to cast up to or about 20%, 40%, 60%, 80%, 100%, or about any percentage therebetween of a unibody vehicle frame (e.g., in one casting). Further, while the present disclosure refers specifically to unibody frames (e.g., unitized body and frame assemblies), the casting machine 100 may also be configured to cast body-on-frames (e.g., separate body and frame assemblies) and components thereof in other embodiments. Further, in some embodiments, casting of Class “A” surface components or portions are specifically excluded from the casting process.

Certain details are set forth in the following description and in FIGS. 1A-6 to provide a thorough understanding of various embodiments of the present disclosure. Other details describing well-known structures and systems often associated with die casting (e.g., injectors, ejectors, pins, runners, lubricants, cores, slides, furnaces, shots, plungers, sleeves), vehicle frames, and assembly, etc., however, are not set forth below to avoid unnecessarily obscuring the description of the various embodiments of the present disclosure.

Many of the details, dimensions, angles and other features shown in FIGS. 1A-6 are merely illustrative of particular embodiments of the present disclosure. Accordingly, other embodiments can include other details, dimensions, angles and features without departing from the spirit or scope of the present invention. In addition, those of ordinary skill in the art will appreciate that further embodiments of the casting machine and method thereof described herein can be practiced without several of the details described below. Various embodiments of the present disclosure can also include structures other than those illustrated in the Figures and are expressly not limited to the structures shown in the Figures. Moreover, the various elements and features illustrated in the Figures may not be drawn to scale.

The casting machine 100 configured in accordance with an embodiment of the present disclosure includes a central housing or hub 102. As illustrated in FIG. 1B, the central hub 102 may include a base platen or plate 103 with a die portion 106 (e.g., cover die portion), with individual sides identified as 106a-106e (e.g., corresponding to left, front, right, rear, and bottom sides), fixedly positioned or coupled to the base plate 103. In some embodiments, the cover die portion 106 is positioned on top or above the base plate 103. The central hub 102 is configured to remain stationary (e.g., fixed in place or position). The cover die portions 106 are configured to remain stationary as corresponding ejector die portions 108 (e.g., identified individually as ejector die portions 108a-108e) translate toward (e.g., to closed positions with the corresponding cover die portions 106) or away (to open positions spaced substantially apart from the corresponding cover die portions 106) from the central hub 102 during a casting process (e.g., as described in more detail below). The ejector die portions 108 may each be coupled to respective platens.

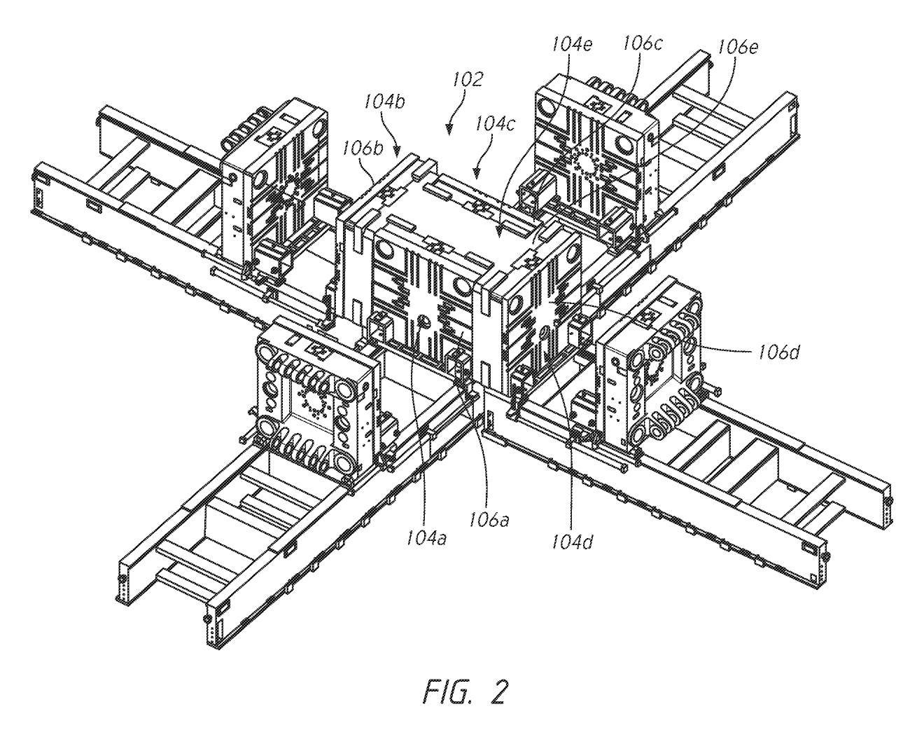

In other embodiments, as illustrated in FIG. 2, the central hub 102 may include a plurality of faces or sides 104 (e.g., identified individually as sides 104a-104f). In other embodiments, the central hub 102 may include less than six sides or more than six sides. The sides 104a-104f may, for example, correspond to left, front, right, rear, and bottom sides of the central hub 102. While illustrated as extending either parallel or perpendicular relative to each other, in other embodiments, the sides 104 may extend at an angle (e.g., obliquely) relative to each other. The central hub 102 may be configured as a substantially solid block (e.g., a monolithically formed block), wherein each side (e.g., sides 104a-104e) acts as a platen or plate with corresponding die portions 106a-106e attached to a side of the central hub 102 as illustrated in FIG. 2.

The central hub 102 may be positioned at a center of an intersection (e.g., a four-way intersection) where rails or tracks 110a-110d meet. The rails or tracks 110a-110d provide a path or guide upon which corresponding ejector die portions 108a-108d may slide or otherwise translate along substantially horizontal axes (e.g., X- and Y-axes) toward or away from the central hub 102 (e.g., and corresponding cover die 106) during a casting process between open and closed positions. As illustrated, in some embodiments, a fifth ejector die portion 108e translates toward or away from the central hub 102 along a vertical axis (e.g., a Z-axis) extending substantially perpendicular to the horizontal axes, overhead or otherwise above the central hub 102. As illustrated, in some embodiments, ejector die portion 108e may translate along one or more support bars or poles 112a-112d that extend upward from the central hub 102 substantially parallel to the Z-axis. The poles 112 may be positioned at four respective corners of the central hub 102 (e.g., cover die portion 106).

Ejector die portions 108a-108e may thus form a mold cavity 114 with corresponding cover die portions 106a-106e for integrally casting (e.g., without having to further weld or otherwise couple separate portions of) a unibody vehicle frame 116. The mold cavity 114 may thus be formed by the multiple ejector die portions 108 in closed positions with respect to the multiple corresponding cover die portions 106. Ejector die portions 108 may include one or more cavity portions 109 configured or shaped to correspond to outer contours or shapes of respective sides and components of the vehicle frame 116. In some embodiments, the ejector die portions 108a-108e may include cavity portions corresponding to side portions (e.g., a left, a front, a right, a rear, and a roof, respectively) and/or portions thereof (e.g., pillars, panels, sills, rails, posts, tie bars, bumpers, reinforcements, wheel houses, and/or shock towers) of the unibody frame 116. For example, ejector die portion 108e may thus include cavity portions configured to correspond to a roof portion and/or other top-side portions thereof (e.g., roof panels, rails, trunk, hood) of the unibody frame 116. Thus, cavity portions 109 of the respective multiple die portions 108 combine to form the mold cavity 114 configured to form a casting of the unibody frame 116. The mold cavity 114 formed by the corresponding ejector and/or cover die portions may be a single cavity die, a multiple cavity die, a combination or family die, and/or a unit die. As described above, a casting formed by the mold cavity 114 may correspond to about or up to about 20%, 40%, 60%, 80%, 100%, or about any percentage therebetween of a complete unibody vehicle frame. The casted unibody vehicle frame 116 may rest or be positioned on a bottom side of cover die portion 106e.

As illustrated in FIGS. 1A-1B, in contrast to conventional mold cavities formed between a cover die half and an ejector die half, in some embodiments, the mold cavity 114 may be formed only by the multiple die cavity portions of ejector die portions 108 when each of the ejector die portions 108a-108e is moved to a closed position at the central hub 102. While referred to as cover die portions 106, the cover die portions 106 may simply act as guides or receptacles configured to receive and align the ejector die portions 108 at the central hub 102 without actual mold cavity portions or recesses as in conventional cover dies. In this manner, the mold cavity 114 is formed (e.g., bordered, shaped) by or made up of the combined cavity portions 109 or recesses of ejector die portions 108 and the “cover die portions 106” form respective sides of the central hub 102 (e.g., left, front, right, rear, and bottom sides). In other embodiments, the cover die portions 106 may also include cavity or recess portions corresponding to the cavity portions 109 of the ejector portions 108 to form the mold cavity 114.

While the die casting machine 100 includes a cover die portion 106 with five sides and five corresponding ejector die portions 108, in other embodiments, die casting machine 100 may include more than or less than five corresponding cover and ejector die portions. As noted above, these die portions may correspond to five or more sides or side portions forming a mold cavity for a unibody vehicle frame. In certain embodiments, the die casting machine 100 does not include corresponding die portions on one or more sides of the central hub 102 (e.g., bottom, top, left, right, front, and/or rear sides). In the illustrated embodiment, the die casting machine 100 does not include corresponding die portions on an underside or bottom side of the central hub 102 opposite the top side. In such configurations, an underfloor or bottom side of a unibody vehicle frame is excluded from the mold cavity 114 as an underfloor may be provided by a battery housing or tray for electric vehicle. In other embodiments, the die casting machine 100 does not include corresponding die portions for casting a top, left, right, front, and/or rear side or portion of a unibody vehicle frame.

A die casting machine 100 with the central hub 102 and multiple die portions 106, 108 configured forming the mold cavity 114 in this manner provides a casting machine with multiple degrees of freedom or multi-directional casting for integrally casting the unibody frame 116. As described above, the multiple ejector die portions 108 may translate along their respective axes (e.g., X-, Y-, and Z-axes) towards and away from the central hub 102 during the casting process and use multiple sides of the central hub 102 as noted above to integrally cast multiple sides or portions of the unibody frame 116. In yet further embodiments, one or more of the ejector die portions 108 and/or platens may be configured to rotate about respective X-, Y-, or Z-axes (e.g., up to 90 degrees, up to 180 degrees) as well as translate to provide additional degrees of freedom for casting additional parts, sides, or portions of the vehicle frame 116, or to cast other vehicle frames different from vehicle frame 116. In some embodiments, the ejector die portions 108 are translated axially with electric propulsion. In such embodiments, tie rods or bars may not be included such that the ejector die portions 108 are rotatable as well as translatable axially.

For example, an ejector die portion 108 may form a first mold cavity portion with a corresponding cover die portion 106 in a first closed position (e.g., rotated 0 degrees about a respective axis) and may form a second mold cavity portion with the corresponding die portion 106 in a second closed position (e.g., rotated 90 degrees about the respective axis). The first and second mold cavities portions may form portions of first and second different mold cavities. The different mold cavities may correspond to castings of unibody frames of different vehicles (e.g., a first and a second vehicle). In some embodiments, the second mold cavity corresponds to a casting for a different portion or part of the same vehicle. In some embodiments, the ejector die portions 108 may be rotated between more than two positions (e.g., three, four, five, six) to provide the ability to form multiple different mold cavities with corresponding cover die portions 106 corresponding to multiple vehicle unibody frames, portions, or components thereof.

In yet other embodiments, in addition to or alternatively to translatable or rotatable ejector die portions configured to provide multiple casting directions and degrees of freedom, the die casting machine 100 may include one or more modular components configured to be replaceable (e.g., interchangeable, switchable, substitutable). For example, the central hub 102 with cover die portions 106 may be a modular component that may be replaced with another central hub having cover die portions corresponding to different vehicle frame portions or vehicle frames. In some embodiments, different die portions 106 may be provided with the same central hub 102. In yet other embodiments, the ejector die portions 108 may be modular and be replaced with different ejector die portions. Such modularity may provide improved servicing of the die casting machine 100 in addition to allowing the die casting machine 100 to cast different vehicle frames and/or frame portions by switching hubs, ejector die portions, or cover die portions.

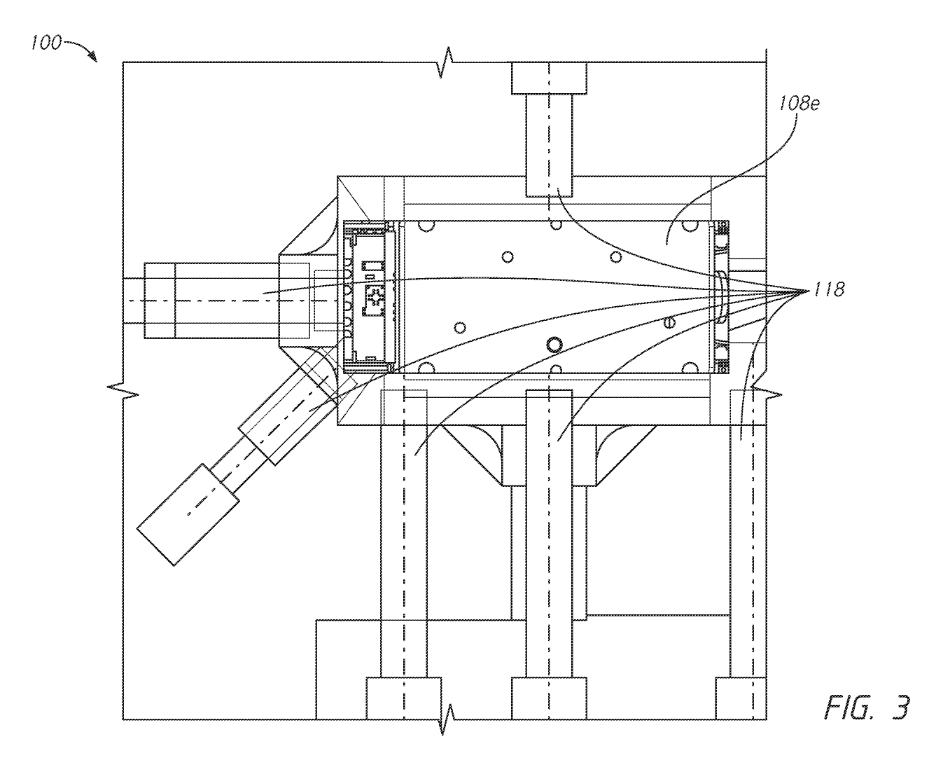

With reference to FIG. 1A, the die casting machine 100 may include multiple injectors 118 fluidly coupled to the die portions and configured to inject molten metal into the mold cavity 114 formed by the multiple corresponding die portions 106 and/or 108 to form a casting of the vehicle frame 116. While die portions 108a-108d are illustrated as including one injector 118 per die or side, in other embodiments, a side or die may include multiple injectors (e.g., more than one injector) as illustrated in FIG. 3 or no injectors (e.g., see ejector die portion 108e). In certain embodiments, ejector die portion 108e may also include one or more injectors 118. The injectors 114 may be positioned on and/or fluidly coupled to an ejector die portion 108 side rather than a cover die portion side as with traditional die cast machines. As such, the die casting machine 100 may include “reverse” injectors providing the center hub 102 with more flexibility or space for other components (e.g., “net-shape” overflows, ejector system components, die lube systems, die thermal regulation systems) as described in more detail below with respect to FIG. 5. The injectors 114 may extend substantially perpendicular and/or obliquely relative to each corresponding ejector die portion. In other embodiments, the cover die portions may additionally or alternatively include one or more injectors 118.

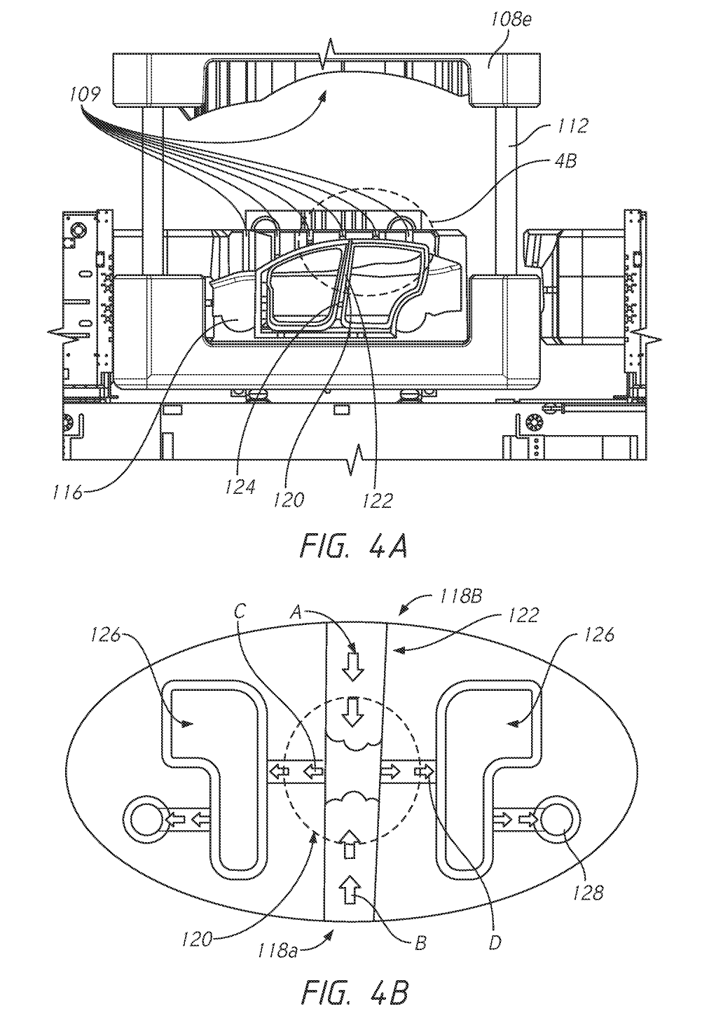

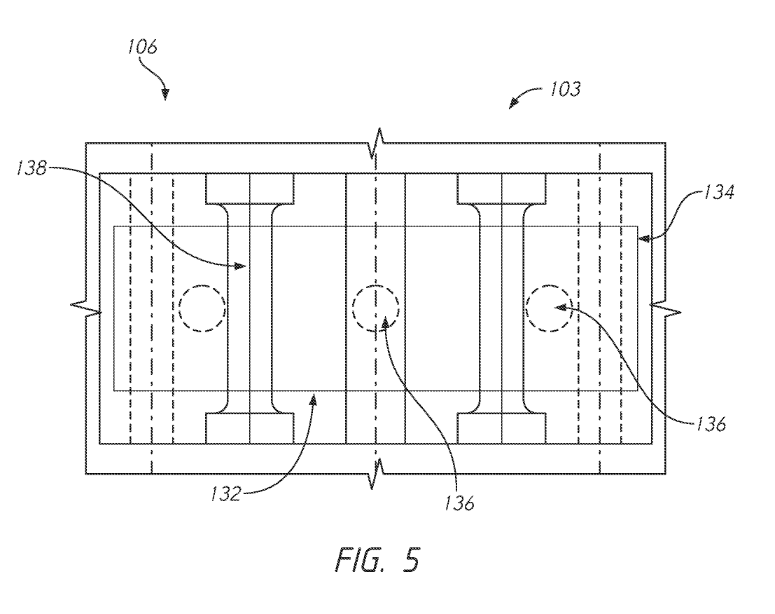

As further illustrated in FIGS. 4A-4B, multiple injectors 118 provide multiple injection points or sources of molten metal into the mold cavity 114 (e.g., and into the multiple cavity or recess portions of the corresponding die portions 106 or 108). FIG. 4A shows a cross-sectional view of a portion of the die casting machine 100 and a casted vehicle frame 116. As an example, molten metal may be injected into a cavity portion 122 of a first ejector die portion (e.g., die portion 108c) corresponding to or forming a side frame component (e.g., a B-Pillar 124). As illustrated in the close-up view of FIG. 4B of the cavity portion 122, molten metal from multiple injectors 118 (e.g., injectors 118a and 118b) enters and fills the cavity portion 122 in opposite directions (e.g., towards each other as identified by arrows A and B) to form the B-Pillar 124. A “slurry or splash” zone 120 is formed where melt fronts of the molten metal from each respective injector meet in the cavity portion 122 as they flow towards each other. A slurry zone 120 is a location where the melt fronts intersect or meet. Typically, the molten metal will meet at the slurry zone 120 and displace in a direction substantially perpendicular to an original flow direction.

As further illustrated in FIG. 4B, the molten metal will displace in substantially perpendicular directions relative to the original flow direction as identified by arrows C and D. The central hub 102 may include one or more “net-shape” overflows 126 or additional casting cavities or recesses for catching or storing the displaced molten metal from the slurry zone. For example, ejector die portion 108c may contain or include the net-shape overflows 126. Molten metal displaced into the net-shape overflows 126 may form additional castings for the vehicle frame. These castings may be for example, frame components that may be difficult to cast integrally with main portions of the vehicle frame 116. For example, shock towers or attachment corners for coupling a battery tray (e.g., that may form a undercarriage or floor of the frame 116) to the vehicle frame 116. Thus, the die casting machine 100 may use net overflow of this molten metal from slurry zone 120. The central hub 102 (e.g., die portions) may further include vents 128 (e.g., vacuum chill vents) to vent the ejector die portions 108.

The die casting machine 100 further includes an ejection system 130 configured to eject a solid or otherwise finished casting of frame 116 out of the mold cavity 114. For example, each of the ejector die portions 108 may include typical or conventional ejection components for ejecting a die out of and away from (e.g., towards the central hub 102 along a substantially horizontal axis) each corresponding ejector die portion 108. For example, the ejection components may include conventional ejector plates, pins, actuators, or other suitable ejection features.

With reference to FIG. 5, the die casting machine 100 also includes a central hub ejector 132. The central hub ejector 132 may include an ejection plate 134 and one or more ejection cylinders 136 positioned within the base plate 103 and/or die portion 106 (e.g., bottom side or floor portion 106e). The ejection cylinders 136 are configured to translate up and down to move the plate 134 towards and away from the central hub 102 in a direction substantially parallel to a vertical axis (e.g., the Z-axis). For example, a finished or completed casting(s) of the frame 116 may be positioned on the ejection plate 134 and ejected upward above the central hub 102 (e.g., towards a ceiling or roof) or to an otherwise elevated position. The ejected casting may then be rotated and/or lifted away from the die casting machine 100 (e.g., by a robot or robotic arm). The base plate 103 and/or die portion 106 may also include one or more support pillars 138 extending between opposing sides (e.g., left and right sides) of the central hub 102. Such pillars 138 may provide support for the hub 102 and/or die portions during a casting process (e.g., during injection of molten metal) to maintain die positioning and structural stability of the machine 100.

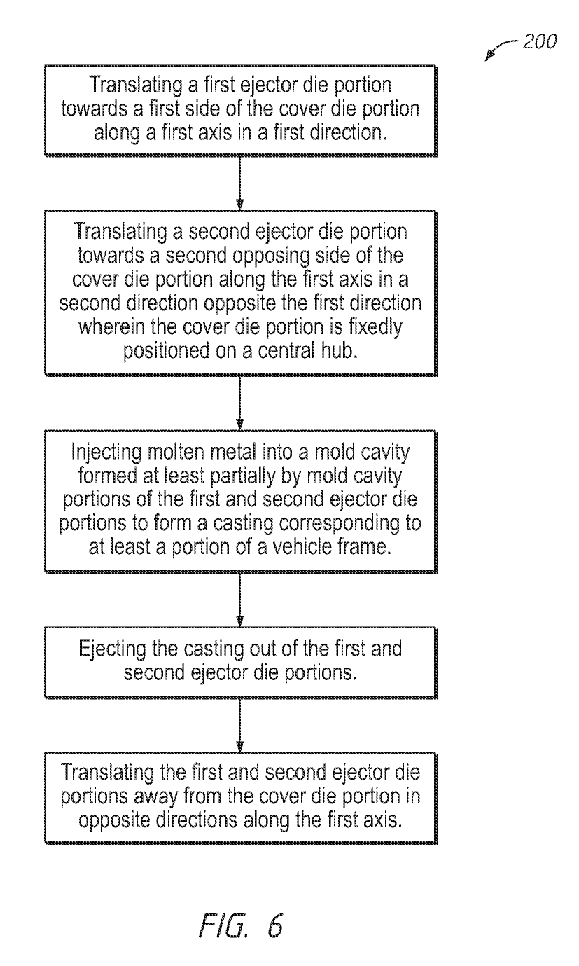

FIG. 6 illustrates an example method 200 of casting (e.g., high-pressure die-casting) a unibody vehicle frame in accordance with embodiments of the present disclosure. The method may include the steps of translating a first ejector die portion (e.g., ejector die portion 108a) towards a first side of a cover die portion (e.g., 106a) along a first axis (e.g., X-axis) in a first direction and translating a second ejector die portion (e.g., ejector die portion 108c) towards a second opposing side of the cover die portion (e.g., 106c) along the first axis in a second direction opposite the first direction. The cover die portion is fixedly positioned on a central hub (e.g., central hub 102). The method further includes injecting molten metal into a mold cavity (e.g., mold cavity 114) formed at least partially by mold cavity portions (e.g., cavity portions 109) of the first and second ejector die portions to form a casting corresponding to at least a portion of a vehicle frame (e.g., vehicle frame 116). The method further includes ejecting the casting out of the first and second ejector die portions and translating the first and second ejector die portions away from the cover die portion in opposite directions along the first axis. As in conventional high pressure die casting, molten metal may be injected into the mold cavity (e.g., mold cavity 114) under high pressure (e.g., between about 1500 to about 25400 psi). Typically, once the mold cavity is filled, pressure is maintained until the casting solidifies. The ejector die portions (e.g., ejector die portions 108) may then be opened and the casting(s) or shot ejected out of the die portion and/or upward relative to the central hub.

In the description above, various embodiments of the present invention are described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described. The subject matter of the present invention is described here with specificity, but the claimed subject matter may be embodied in other ways, may include different elements or steps, and may be used in conjunction with other existing or future technologies.

This description should not be interpreted as implying any particular order or arrangement among or between various steps or elements except when the order of individual steps or arrangement of elements is explicitly described. Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A multi-directional casting machine for casting a frame of a vehicle, the casting machine comprising:
a central hub having a cover die portion;
a plurality of ejector die portions translatable relative to the cover die portion, the plurality of ejector die portions configured to meet at the central hub and including:
a first ejector die portion configured to translate along a first axis between a closed position and an open position, the first ejector die portion being adjacent a first side of the cover die portion in the closed position and spaced apart from the cover die portion in the open position,
a second ejector die portion configured to translate along the first axis between a closed position and an open position, the second ejector die portion being adjacent a second side of the cover die portion opposite the first side in the closed position and spaced apart from the cover die portion in the open position, and
a third ejector die portion configured to translate along a second axis extending substantially perpendicular to the first axis between a closed position and an open position, the third ejector die portion being adjacent a third side of the cover die portion in the closed position and spaced apart from the cover die portion in the open position, wherein the plurality of ejector die portions form a mold cavity corresponding to at least a portion of a vehicle frame.

2. The casting machine of claim 1, further comprising:
a fourth ejector die portion configured to translate along a third axis extending substantially perpendicular to the first and second axes between a closed position and an open position, the fourth ejector die portion being adjacent a fourth side of the cover die portion in the closed position and spaced apart from the cover die portion in the open position.

3. The casting machine of claim 2, further comprising:
a fifth ejector die portion configured to translate along the third axis extending substantially perpendicular to the first and second axes between a closed position and an open position, the fifth ejector die portion being adjacent a fifth side of the cover die portion opposite the fourth side in the closed position and spaced apart from the cover die portion in the open position.

4. The casting machine of claim 3, wherein the first and second ejector die portions include cavity portions corresponding to opposing side portions of the vehicle frame, the third ejector die portion includes cavity portions corresponding to a roof portion of the vehicle frame, and the fourth and fifth ejector die portions include cavity portions corresponding to front and rear portions of the vehicle frame, respectively.

5. The casting machine of claim 4, wherein the side, roof, front, and rear portions of the vehicle frame are configured to be integrally formed within the mold cavity by the casting machine.

6. The casting machine of claim 3, further comprising a plurality of injectors configured to inject molten metal into the mold cavity.

7. The casting machine of claim 6, wherein at least one of the translatable ejector die portions is fluidly coupled to at least one injector such that the molten metal is injected into the mold cavity through the at least one translatable ejector die portion.

8. The casting machine of claim 3, wherein the translatable ejector die portions are configured to translate along their respective axes via electric propulsion.

9. The casting machine of claim 3, further comprising an ejection system, wherein the ejection system is configured to eject a casting of a vehicle frame in an upward direction away from the central hub.

10. The casting machine of claim 9, wherein the ejection system is operably coupled to the central hub.

11. The casting machine of claim 9, wherein at least one of the translatable ejector die portions includes an ejection system configured to eject a portion of a casting of a vehicle frame out of the ejector die portion.

12. The casting machine of claim 1, wherein at least one of the translatable ejector die portions is rotatable relative to a respective axis.

13. A multi-directional casting machine for casting a frame of a vehicle, the casting machine comprising:
a central hub configured to receive a plurality of translatable ejector die portions, wherein the plurality of ejector die portions are configured to form a mold cavity when received by the central hub, the mold cavity corresponding to at least a portion of a vehicle frame; and
an ejection system operably coupled to the central hub and configured to eject a casting of the vehicle frame in an upward direction along a substantially vertical axis relative to the central hub after the vehicle frame has been casted in the mold cavity.

14. The casting machine of claim 13, wherein the plurality of translatable ejector die portions includes a first translatable ejector die portion configured to translate along the substantially vertical axis towards and away from the central hub and includes mold cavity portions corresponding to a roof portion of the vehicle frame.

15. The casting machine of claim 13, wherein the plurality of translatable ejector die portions includes translatable ejector die portions configured to translate along a substantially horizontal axis towards and away from the central hub, the ejector die portions including mold cavity portions corresponding to opposing side portions of the vehicle frame.

16. A method of casting a frame of a vehicle, the method comprising:
translating a first ejector die portion towards a first side of a cover die portion along a first axis in a first direction;
translating a second ejector die portion towards a second opposing side of the cover die portion along the first axis in a second direction opposite the first direction, wherein the cover die portion is fixedly positioned on a central hub;
injecting molten metal into a mold cavity formed at least partially by mold cavity portions of the first and second ejector die portions to form a casting corresponding to at least a portion of a vehicle frame;
ejecting the casting out of the first and second ejector die portions; and
translating the first and second ejector die portions away from the cover die portion in opposite directions along the first axis.

17. The method of casting a frame of a vehicle of claim 16, wherein the mold cavity portions of the first and second ejector die portions correspond to opposing sides portions of the vehicle frame.

18. The method of casting a frame of a vehicle of claim 17, further comprising:
translating a third ejector die portion towards a third side of the cover die portion along a second axis substantially perpendicular to the first axis;
wherein the mold cavity is formed at least partially by mold cavity portions of the first, second, and third ejector die portions; and
ejecting the casting upward relative to the cover die portion along the second axis.

19. The method of casting a frame of a vehicle of claim 18, further comprising:
translating a fourth ejector die portion towards a fourth side of the cover die portion along a third axis substantially perpendicular to the first and second axes;
translating a fifth ejector die portion towards a fifth side of the cover die portion along the third axis in a direction opposite the fourth ejector die portion; and
wherein the mold cavity is formed at least partially by mold cavity portions of the first, second, third, fourth, and fifth ejector die portions.

20. The method of casting a frame of a vehicle of claim 19, wherein the mold cavity portions of the third ejector die portion correspond to a roof portion of the vehicle frame and the mold cavity portions of the fourth and fifth ejector die portions correspond to front and rear portions of the vehicle frame, respectively, and wherein the side, roof, front, and rear portions of the vehicle frame are integrally formed during casting.
